(19) United States
(12) Patent Application Publication
(10) Pub. No.: US 2009/0220720 A1
(43) Pub. Date: Sep. 3, 2009

(54) Roofing material with release liner having adhesive

(76) Inventors: Shaik Mohseen, Austin, TX (US); Natalino Zanchetta, Reno, NV (US)

Correspondence Address: KENYON & KENYON LLP, ONE BROADWAY, NEW YORK, NY, 10004, US

(21) Appl. No.: 11/921,671

(22) PCT Filed: Jan. 9, 2006
(86) PCT No.: PCT/US06/00629

§ 371 Date: Apr. 27, 2009

(51) Int. Cl. E04B 1/02; B32B 33/00; B32B 37/12; D06N 5/00

(52) U.S. Cl. 428/41.7; 428/40.1; 156/60

(57) ABSTRACT

A roofing material having release tape having a substrate with adhesive capable of transfer from the substrate to the roofing material, and a method of producing same.

### FIELD OF THE INVENTION

This invention relates to roofing material having adhesive selvages, laps, or strips for sealing contiguous roofing material, and process for making the same.

### BACKGROUND OF THE INVENTION

There are many types of roofing materials that are applied to roofs for waterproofing a structure and protecting it from the elements. For example, bitumen-based membranes, single ply shingles, and laminated shingles are well known in the roofing industry for use on commercial, industrial, and residential structures.

Bitumen-based self-adhesive waterproofing membranes have been designed with an improved edge for convenient sealing to a contiguous membrane. Such membranes provide a lateral section of bitumen that is covered by protective tape, which is typically made of siliconized polyester, polypropylene, or polyethylene film of 25 to 70 microns in thickness. This protected section is generally termed a “selvage” or “lap.” The protective tape assures that up to the time of installation the surface of the membrane is clean and free of granules or other materials. On installation, the protective tape is removed to expose the selvage section, which is now available for contact with a bottom adhesive portion of a contiguous membrane. A water barrier seal is formed without requiring hot mopping asphalt, torch-application, or adherence with cold-process adhesives. See, e.g., U.S. Pat. Nos. 5,766,729, 5,843,522, 5,964,946, 6,696,125, 6,924,015, and U.S. Published Application No. 2004/0161570, which are incorporated herein by reference in their entireties.

Protective tape is used on roofing underlayerment, single ply shingles and laminated shingles to cover strips or striations of bitumen, or other adhesive compounds, up to the time of installation. The protective tape is removed on installation so that the underlayerment can bond or adhere to the roof deck, or the shingles can bond or adhere to shingles in the next course to form a more secure installation.

It is well known that self-adhesive roofing materials are used all over the country throughout the year. It is also known that the required bonding strength is achieved in products based on self-adhesive technology in the presence of heat and pressure, which act as catalyst to attain a permanent seal. However, when these products are used during colder climatic conditions, the element of “heat” is lacking or insufficient. Whereas it is possible to recommend the use of a hot air gun to activate the adhesive at the lap seams, this technique is dangerous and time consuming. It was found that the application of a thin layer or adhesive coating, i.e., a width of adhesive coating, consisting of a tackifying resin or commercially available pressure-sensitive adhesive (“PSA”) to the laps provided a good initial seal between adjacent rolls. The initial seal is adequate to last at least until the warmth of a summer season, brings heat sufficient to permanently lap bond the entire lap joint over time.

Application of adhesive directly to a membrane is disadvantageous for several reasons. First, the adhesive must be applied with machinery and would typically be sprayed onto the selvage. Spraying does not always lead to a complete and homogeneous adhesive coating. Spraying typically leaves portions of the selvage uncovered by adhesive. Furthermore, because the volume of adhesive sprayed cannot be adjusted to the speed of the processing line, the adhesive coating often varies in thickness depending upon how fast or slow the line is progressing at the time the coating is being applied. Furthermore, the machinery used to spray on the adhesive can only be used to spray adhesives having a viscosity within a limited range. Thus, while more viscous adhesives, which are stronger, are generally preferable for this particular application, they cannot be used in the spraying machinery. Finally, with respect to transverse selvage, adhesive is practically impossible to apply transversely on a moving line.

When choosing the type of protective tape, or liner, several factors need to be taken into consideration. First, it is important to select a liner that will not undergo any distortion during manufacturing. Next, the liner should release with relative ease during installation of the material. Typically, during hot weather conditions, such liners have a tendency to stick to the bituminous compound and tear when attempted to remove from the membrane. Another important parameter to consider is the appropriate thickness of the liners. Thicker liners are easier to release but could pose some problems during manufacture and are proportionally expensive. Another important factor is the quantity and quality of the release agent such as silicone that is applied on the liner. Such release liners may be made of polyethylene, polypropylene or polyester; however, polyester is preferred for this application due to their high temperature resistance characteristics. Whereas polyester is the most expensive of these materials, it offers the most heat resistance, which is very critical in this application. Thickness of such liners employed for this application can range from 0.5 mil (0.0125 mm) to 2 mil (0.050 mm); however a 1.5 mil (0.0375 mm) is preferred.

An object of the invention is to provide roofing materials with improved adhesion characteristics to other roofing materials, particularly at the overlap areas.

### SUMMARY OF THE INVENTION

A roofing material is provided with a release tape wherein the release tape comprises a substrate and an adhesive capable of transfer from the substrate to the roofing material.

In a non-limiting preferred embodiment of the invention, the release tape comprises a substrate and an adhesive capable of transfer from the surface to a bituminous surface of the roofing material such that the adhesive can transfer from the substrate to the bituminous surface of the roofing material. Preferably, the release tape is a polyester-based material, siliconized on both sides and coated with a pressure sensitive adhesive on one side, such as PSA 81570. In a further non-limiting embodiment, a lacquer is applied on the side opposite the pressure sensitive adhesive side.

In a first alternative non-limiting embodiment, the roofing material is a bitumen-based membrane.

In a second alternative non-limiting embodiment of the invention, the roofing material is a single ply roofing shingle.

In a third alternative non-limiting embodiment of the invention, the roofing material is a laminated roofing shingle.

In accordance with another aspect of the invention, a method of making roofing material having release tape comprising a substrate with an adhesive capable of transfer to the roofing material is provided, comprising the step of applying to the roofing material a removable release tape comprising a substrate pre-treated with an adhesive such that the adhesive contacts the roofing material and remains on the roofing material upon removal of the substrate.

### BRIEF DESCRIPTION OF THE FIGURES

Exemplary embodiments of the present invention will now be described in detail with reference to the accompanying drawings in which: FIG. 1A is an exploded perspective view of a bitumen-based roofing membrane composite sheet with release tape in accordance with the first alternative embodiment of the invention;

FIG. 1B is a cross-sectional view of the embodiment of FIG. 1A along plane I.

FIG. 1C is a cross-sectional view of the embodiment of FIG. 1A along plane II.

FIG. 2A is an exploded perspective view of a three tab roofing shingle in accordance with the second alternative embodiment of the invention;

FIG. 2B is a cross-sectional view of the embodiment of FIG. 2A along plane III.

FIG. 3A is an exploded perspective view of a laminated roofing shingle in accordance with the third alternative embodiment of the invention;

FIG. 3B is a cross-sectional view of the embodiment of FIG. 3A along plane IV;

FIG. 4A is a plan bottom view of release tape having a generally uniform application of adhesive in accordance with a non-limiting embodiment of the invention;

FIGS. 4B to 4E are plan bottom views of release tape having alternative zones of adhesive in accordance with other non-limiting embodiments of the invention;

FIG. 5A is a cross-sectional view of release tape having an adhesive on a substrate in accordance with the invention;

FIG. 5B is a cross-sectional view of release tape having a protective layer in removable contact with the adhesive layer of the release tape in accordance with the invention;

FIG. 5C is a cross-sectional view of release tape in accordance with the invention having a protective film on a surface of the release tape opposing to the adhesive layer to permit rolling and unrolling of the release film prior to its application to the roofing material in accordance with the invention;

FIG. 5D is a cross-section view of release tape in accordance with the invention having an adhesive layer, a silicone layer, a substrate layer, a second silicone layer, and a protective layer to permit improved rolling and unrolling of the release film prior to its application to the roofing material; and

FIG. 6 is a schematic view of a process for manufacturing a roofing material having a release tape with a substrate and an adhesive in accordance with the invention.

The dimensions of the elements in the illustrations are not proportionate, but are only representative of the actual and relative dimensions of the elements.

### DETAILED DESCRIPTION OF THE INVENTION

The invention will be illustrated and described in more detail with particular reference to the roofing materials shown in the accompanying figures and in the following description of exemplary preferred embodiments.

This invention relates to roofing material comprising a release tape having a substrate with an adhesive capable of transfer from the substrate to the roofing material.

The roofing material of the present invention includes a variety of roofing materials, including bitumen-based membranes, single ply shingles, laminated shingles and roofing underlayerment.

The release tape of the present invention comprises a substrate and an adhesive.

In order to provide adhesion and a watertight seal between a modified bitumen compound on the upper surface of a membrane and a self-adhesive compound on the lower surface of an adjacent membrane, an adhesive that is compatible with both the modified bituminous coating layers and the self-adhesive compound layers must be utilized on the overlap areas. For this purpose, preferred choices of adhesive are pressure sensitive adhesives (“PSAs”) that are commercially available. PSAs are based on silicones, rubber or acrylates. For this application a Styrene-Isoprene-Styrene (“SIS”) rubber based adhesive is preferred because of its superior tack properties at low temperatures to adhere to the surfaces of the modified bitumen compound on the upper surface of the membrane and the lower surface of an adjacent membrane and its low cost. For example, a preferred PSA selected for this use is manufactured and sold by Forbo Adhesives (formerly Reichhold Corporation), Research Triangle Park, N.C., under the trade name of SWIFT 81570. PSA 81570 has excellent tack properties at low temperatures, which is very critical for this application. It is a fast setting adhesive, designed for good performance and good machining at high production speeds.

PSA 81570 is a hot pressure sensitive adhesive that is formulated for use in “peel and stick” applications. It has good adhesion characteristics and plasticizer migration resistance. The viscosity of PSA 81570 is about 7,000 to about 13,000 cPs at 350 degrees Fahrenheit and a softening point at about 199 degrees Fahrenheit to about 209 degrees Fahrenheit. PSA 81570 is particularly effective to adhere to both the self-adhesive compound and the modified bitumen because they are both asphalt based materials.

Other PSAs that may be employed in this application include SWIFT 2H776, a pressure sensitive hot melt adhesive that has excellent adhesion characteristics and considerable versatility. The viscosity is about 1,100 cPs to 1,500 cPs at 350 degrees F.

Another PSA that is suitable for this application is SWIFT 84491, which is a fast-setting, adhesive that has good adhesive and mechanical properties. The typical viscosity of PSA 84491 is 3,900 cPs to 5,200 cPs at 350 degrees F.

Yet another PSA that may be used in this application is SWIFT 84024 that has a viscosity of 2,800 cPs to 5,000 cPs at 350 degrees F. and a softening point of 114 degrees C.

Other compounds that could be used as an alternative to or in combination with PSAs include tackifiers such as Poly Vinyl Butyral (“PVB”).

In a non-limiting preferred embodiment of the invention, the adhesive is capable of transfer from the substrate to a bituminous surface of a roofing material.

This invention further provides a method of making roofing material having release tape having a substrate with an adhesive capable of transfer to the roofing material, comprising the steps of applying to the roofing material a removable release tape having a substrate pre-treated with an adhesive such that the adhesive contacts the roofing material.

Bitumen-based membrane in accordance with this invention may be constructed with one or more compounds structured in single or multiple layers. In one preferred embodiment, the bitumen-based membrane is a dual compound composition constructed of a first APP or SBS modified asphaltic layer on the front side of a carrier sheet and a second self-adhesive asphaltic layer on the back side of the carrier sheet. The second asphaltic layer is very adherent and provides excellent adhesion of the membrane to the underlying surface. Strips of adhesive are applied on the side lap and end lap areas to enhance bonding strength. Release tape in accordance with the present invention is applied, in this non-limiting embodiment, to the upper surface of the composite sheet such that the adhesive on the substrate of the release tape contacts the upper surface of the membrane. The release tape of the present invention may be applied to side lap and end lap areas.

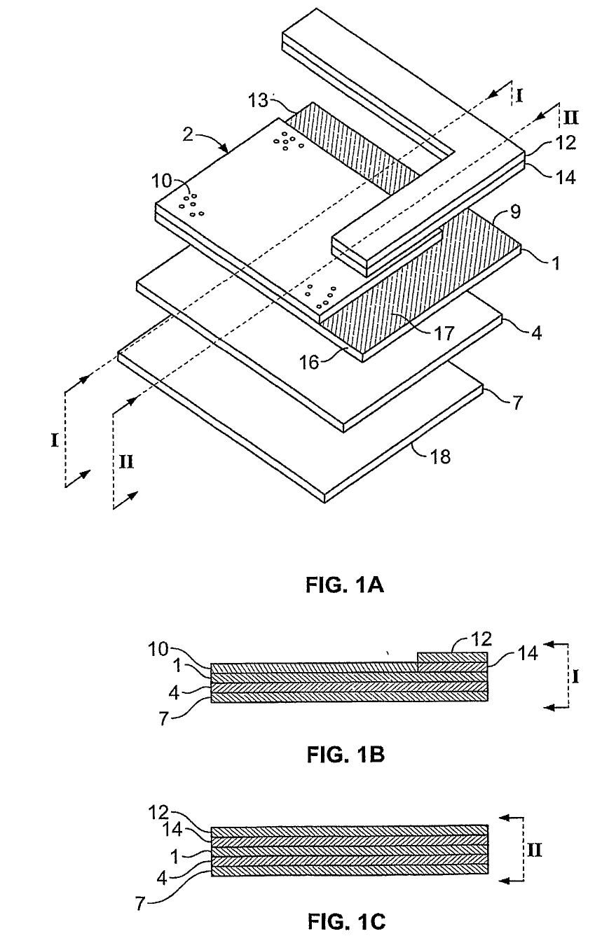

Referring now to the drawings, FIG. 1 illustrates a bituminous self-adhesive membrane constructed in accordance with the present invention and is shown in an exploded view. The composite sheet 2 is made with modified asphalt coatings and a reinforcing carrier sheet 4. Specifically, composite sheet 2 includes a reinforcing carrier 4 sandwiched between upper and lower layers, 1 and 7, respectively, of modified bitumen coatings, which form oppositely exposed upper and lower surfaces, 9 and 18, respectively, of the composite sheet 2. The lower layer 7 has an adhesive polymer-modified compound that constitutes a non-weathering surface adapted to be secured to the underlying surface. The upper layer 1 is an APP compound and the lower layer 7 is a separate, but compatible, self-adhesive compound. Between the upper and lower layers, 1 and 7 respectively, is a reinforcing carrier sheet core 4, preferably made of a fiberglass or polyester substrate. Alternatively, the reinforcing carrier sheet 4 may be formed of a composite material that is a combination of both polyester and fiberglass creating a stronger reinforcement carrier sheet 4. Surfacing agents 10, such as roofing granules, talc or sand for cap sheets and base sheets, fabric surfacing for metal underlayments or mineral granules for tile underlayments, are applied to the upper surface of the upper asphaltic coating layer 1 to impart weathering, high temperature resistance and skid resistance. Roofing granules are made of naturally occurring base rock material and are commonly known as quartz or crystalline silica. Talc used is another naturally occurring material that is predominantly calcium carbonate. Sand utilized for this application is chemically classified as crystalline silica. Lightweight polyester or polypropylene fabric material with no binder is used to cover the top surface of metal roofing underlayments. All of the above surfacing materials are commercially available.

Release tape substrate 12 (and adhesive 14) is placed along the length of the roll on one side of the composite sheet 2, forming a side lap 13, or selvage. This inventive release tape would replace the protective selvage film disclosed in U.S. Pat. No. 6,924,015. The side lap allows for overlapping one roll over another widthwise upon installation. In this embodiment, the release tape substrate 12 with adhesive 14 is also positioned across the width of the sheet 2 at regular intervals to provide a granule-free end lap 16. For more detail on the end lap protection of a roll of roofing membrane see U.S. Pat. Nos. 6,924,015, 5,843,522 and 5,766,729, which are incorporated by reference herein in their entireties. The protected end lap 16 feature allows a granule-free surface at the end of each roll and facilitates easy installation when overlapping one roll over another lengthwise. Additionally, the side lap 13 feature allows a granule-free surface on the selvage of each roll and facilitates easy installation when overlapping one roll over another widthwise. On installation, release tape substrate 12 is removed leaving adhesive 14 on the end lap 16 and side lap 13 portions of the sheet 2.

The presence of the adhesive in accordance with this invention allows the application of such membranes under low temperature conditions, without compromising the integrity of the roof, and without the time, danger and expense of field-applied heat.

Optionally, the release tape 12 with adhesive 14 is applied to the roofing material, which has been pre-treated with a second adhesive directly to the side lap 13 and/or end lap 16 portions of the sheet 2 before the application of the release tape 12 and adhesive 14. Such second adhesive 17 may include a tackifying resin or commercially available pressure-sensitive adhesive (PSA), PolyVinyl Butyral (PVB), or the same or different compounds as the adhesive 14.

FIGS. 1B and 1C are cross-sectional views of the embodiment illustrated in FIG. 1A along planes I and II. Plane I illustrates a transverse section through a portion of the shingle wherein the release tape substrate 12 and adhesive 14 contact the side lap 13 portion of the sheet 2. The dimensions of the elements in the illustrations are not proportionate, but are only representative of the elements. For example, the release tape substrate 12 and adhesive 14 may be significantly smaller in height than the layer of surface granules 10 and the relative height of the composite sheet layers 1, 4, and 7, may be the same or different from each other. Plane II illustrates a transverse section through an end lap 16 portion of the membrane sheet 2.

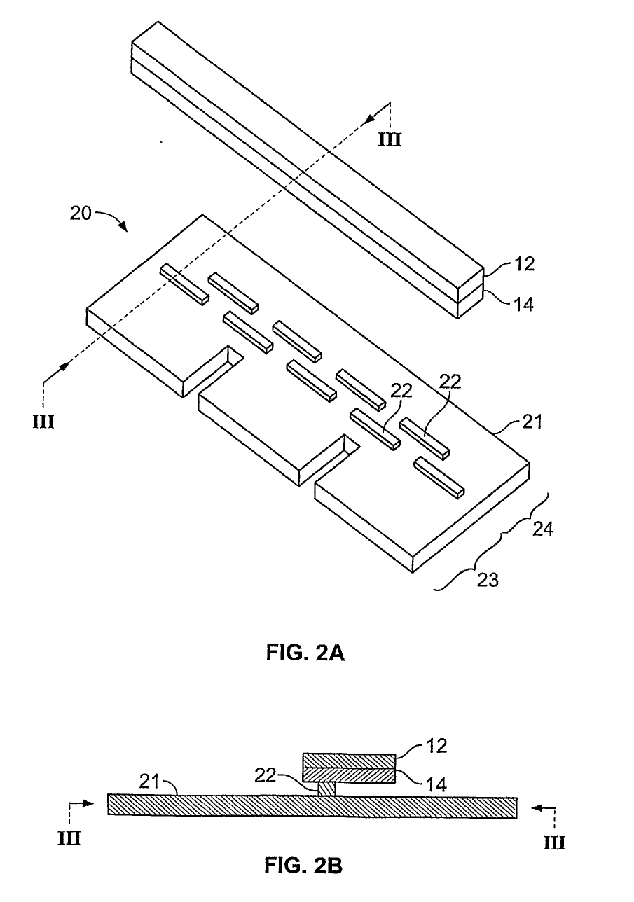

FIG. 2A illustrates a second alternative non-limiting embodiment of the invention providing a single ply roofing shingle with release tape in an exploded view. Single ply roofing shingles are well known in the art and have a variety of shapes. FIG. 2A illustrates a three tab roofing shingle 21 with release tape substrate 12 and adhesive 14. It is also known in the art for roofing shingles to have one or more rows of adhesive strips 22 on the head lap 24 portion of the shingle (i.e., the portion of the shingle to be covered by the next course of shingles) in relatively close proximity to the butt lap 23 portion of the shingle (i.e., the exposed portion of the shingle). The purpose of these adhesive strips 22 being to form a bond between the butt lap portion of the shingle and the underside of the head lap portion of a shingle in the next course of shingles on the roof deck. Release tape in accordance with the present invention is applied, in this non-limiting embodiment, to the upper surface of the three tab shingle such that the adhesive 14 on the substrate 12 of the release tape contacts the adhesive strips 22 on the shingle. At the time of installation, the release tape adhesive 14 improves the initial seal and allows the adhesive strips to bond to the shingle in the next course under lower temperature conditions and higher wind conditions, without compromising the integrity of the roof.

FIG. 2B is a cross-sectional view of the embodiment illustrated in FIG. 2A along plane III. Plane III illustrates a transverse section through a portion of the shingle wherein the release tape substrate 12 and adhesive 14 contact an adhesive strip on the shingle 21. The dimensions of the elements in the illustrations are not proportionate, but are only representative of the elements. For example, the release tape substrate 12 and adhesive 14 may contact the surface of shingle 21 and adhesive may transfer to the shingle surface, further contributing to an enhanced seal between the shingle and the shingle in the next course. In addition, the number, orientation, and position of the adhesive strips and tabs may vary.

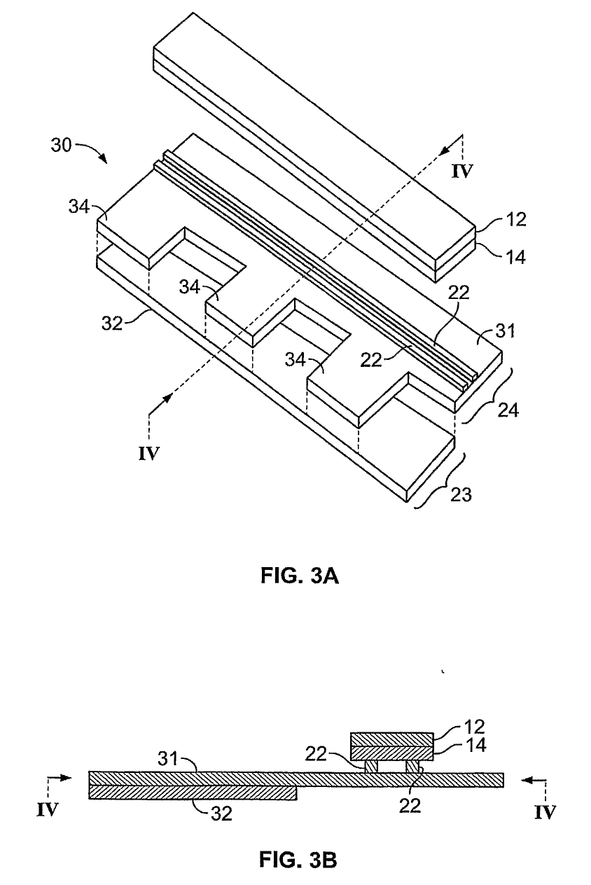

FIG. 3A illustrates a third alternative non-limiting embodiment of the invention providing a laminated roofing shingle 31 and 32 with release tape substrate 12 and adhesive 14 in an exploded view. It is known in the art for laminated roofing shingles to have a variety of designs, including the shingle composite 31 and 32 illustrated in FIG. 3A. It is also known in the art for laminated roofing shingles to have one or more rows of adhesive strips 22 on the head lap 24 portion of the shingle in relatively close proximity to the butt lap 23 portion of the shingle. The purpose of these adhesive strips 22 being to form a bond between the butt lap portion of the shingle and the underside of the backer sheet 32 of the head lap portion of a laminated shingle in the next course of shingles on the roof deck. Release tape in accordance with the present invention is applied, in this non-limiting embodiment, to the upper surface of the laminated shingle such that the adhesive 14 on the substrate 12 of the release tape contacts the adhesive strips 22 on the shingle. One or more release tapes may be applied depending upon the number of rows of strips. The release tape of this non-limiting embodiment of the invention is illustrated as contacting both adhesive strip rows 22. At the time of installation, the release tape adhesive 14 improves the initial seal and allows the adhesive strips to bond to the shingle in the next course under lower temperature conditions and higher wind conditions, without compromising the integrity of the roof.

FIG. 3B is a cross-sectional view of the embodiment illustrated in FIG. 3A along plane IV. Plane IV illustrates a transverse section through a portion of the shingle wherein the release tape substrate 12 and adhesive 14 contacts both rows of adhesive strips 22 as well as the shingle tab 34 and backer sheet 32 on laminated shingle 30. The dimensions of the elements in the illustrations are not proportionate, but are only representative of the elements. For example, the release tape substrate 12 and adhesive 14 may contact the surface of shingle 31 and adhesive may transfer to the shingle surface, further contributing to an enhanced seal between the laminated shingle and the shingle in the next course. Further, the number, orientation, and position of the adhesive strips and tabs may vary.

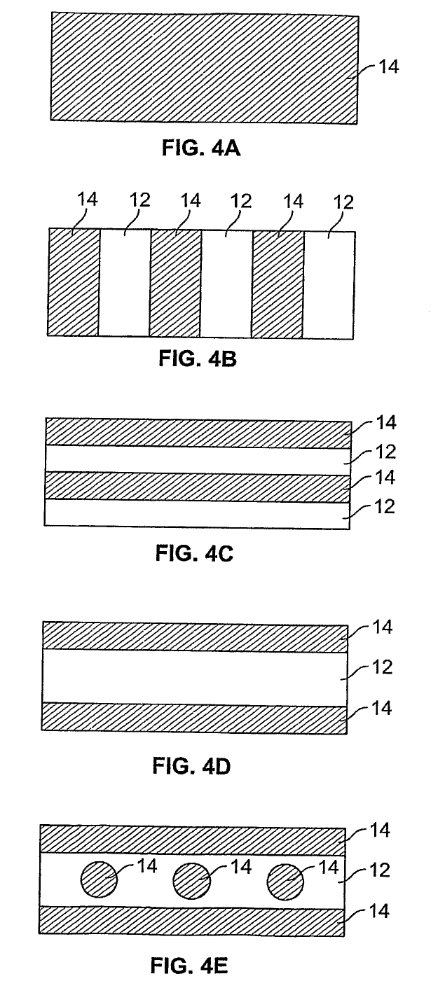

FIGS. 4A-F illustrate from a bottom plan view various non-limiting patterns of application of adhesive to the substrate. In the illustrations of FIGS. 4A and 4F, the adhesive 14 is generally uniform, whereas in FIGS. 4B to 4D, the adhesive is applied in alternating horizontal and/or vertical bands. The number, orientation position, and configuration of adhesive portions on the substrate 12 may vary. FIG. 4E illustrates a combination of bands and other areas of application of adhesive, in this case shown as circles of adhesive. The number, orientation, position, and configuration of the adhesive portions 14 on the substrate 12 may vary.

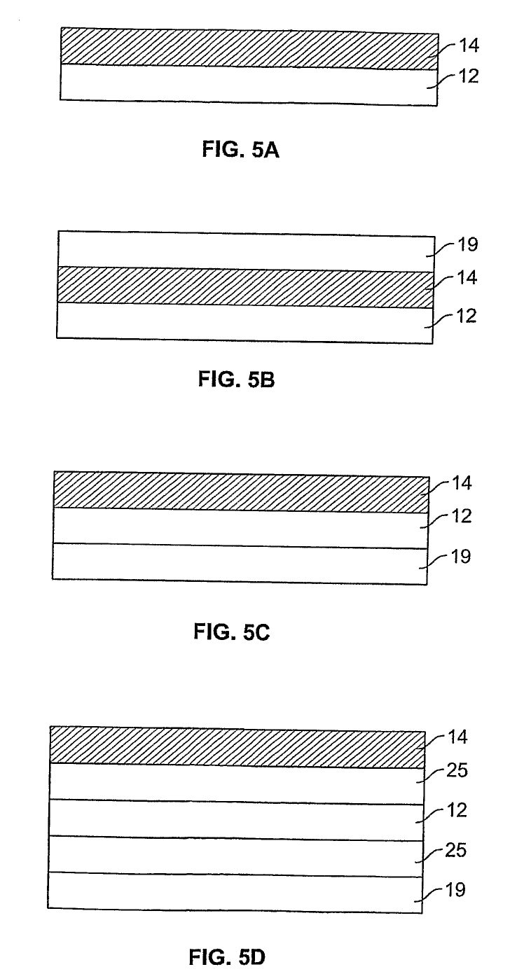

FIGS. 5B to 5D illustrate exemplary embodiments from cross-sectional views of release tape in accordance with this invention designed to preserve the adherence of the adhesive to the substrate of the release tape before the release tape is applied to roofing material. FIG. 5B illustrates release tape in accordance with this invention having a substrate 12 with an adhesive 14 as illustrated in FIG. 5A with an added protective layer 19. The release tape in accordance with the invention may then be manufactured and rolled without transfer of the adhesive 14 to other surfaces. The protective layer 19 would be removed before applying the release tape to the roofing material. In the embodiment shown in FIG. 5B, the release tape with protective layer 19 can be rolled upon itself or on a support structure without transfer of the adhesive until desired after removal of the protective layer 19.

In the embodiment shown in FIG. 5C, the protective layer 19 is applied to the substrate 12 on the side opposite of the adhesive layer 14. This embodiment would permit rolling and unrolling of the release tape on itself prior to its application to the roofing material without transferring adhesive until desired. In this embodiment, it would not be necessary to remove the protective layer 19 from the release tape because the adhesive 14 will be available to adhere to the roofing material when the release tape is unrolled. The composition of the protective layer 19 allows for the adhesive 14 to remain on the substrate 12 upon unrolling of the release tape.

In FIG. 5D, a silicone layer 25 is illustrated on either side of substrate 12 and adhesive layer 14 and a protective layer 19 are illustrated on opposing sides. During the manufacturing process, the coated substrate may be wound such that the side with the pressure sensitive adhesive coating comes into contact with the protective layer on the opposite side.

In various non-limiting embodiments, a polymeric substrate, comprising polyethylene, polypropylene, polyamide or a combination thereof, is coated on one or both sides with one or more release agents 25, preferably silicone. The release agents may have the same or different release characteristics on either side of the substrate. In addition, one side of the silicone coated polymeric substrate may be further coated with a protective layer 19 comprising a breakaway compound, preferably lacquer. The opposite side of the silicone coated polymeric substrate is preferably coated with 0.4 mil to 1.4 mil of one or more pressure sensitive adhesive (“PSA”). The one or more PSA is preferably applied in the form of a thin film; however it may also be applied in the form of various geometric patterns. In these and all of the embodiments herein, the substrate may be made of a single or multiple or layers of material.

Various types of breakaway compounds, such as lacquer, sand, filler material, films, or fabrics, may be used individually or in combination as the protective layer to allow prevent the adhesive coating from coming into contact with machine parts when the release tape is manufactured and when it is applied to the roofing material. Various types of release agents, such as silicone, may be used individually or in combination between the substrate and the adhesive to provide a separating interface when the release tape is removed from the roofing material at the time of installation of the roofing material.

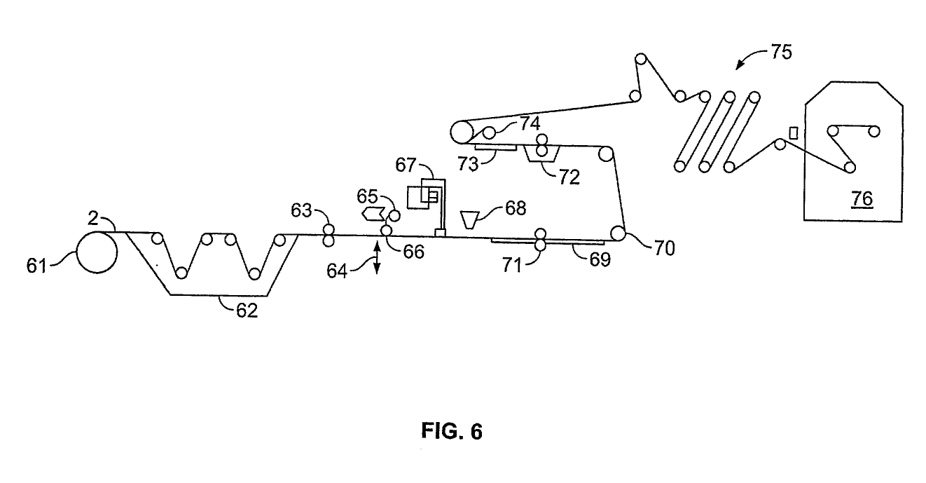

FIG. 6 illustrates a non-limiting apparatus and method of manufacturing roofing material having a substrate with an adhesive capable of transfer from the substrate to the roofing material.

One or more reinforcement carrier sheets 2, which may be polyester, fiberglass, or a polyester/fiberglass combination, is unwound from a mat unwinding station 61, and saturated with modified bitumen compound upper layer in the saturation tank 62, containing for example APP, SBS, PPO, or combinations thereof. Coating thickness is controlled using calender rolls 63 immediately after the saturated carrier sheet 2 comes out of the saturation tank 62. The compound from the carrier sheet back side is scraped off using a scraper 64 in order to facilitate application of the self-adhesive compound lower layer on the carrier back side of the carrier sheet 2 during a later stage in the manufacturing process. FIG. 6 illustrates one non-limiting method of applying a release tape substrate 12 with adhesive 14 to the side lap 13 and end lap 16 portions of the carrier sheet 2 roofing material. In this method, once the compound from the carrier sheet back side is scraped off, the release tape substrate 12 with adhesive 14 is dispensed from a release tape roll 65 and applied to the side lap 13 of the composite 2 using a selvage film applicator 66. Then the release tape substrate 12 with adhesive 14 is applied to the end lap 16 using an end lap film applicator 67 across the width of the composite sheet 2. Directly following these applications, surfacing agents 10 are applied using the surfacing applicator 68. After the surfacing application process, the composite sheet 2 undergoes cooling by traveling on a chilled water bath 69 and over cooling drums 70 and typically is cooled to about 95 degrees Celsius. If granules are applied as surfacing agents 10, the roofing composite sheet 2 is continued through the production line over granular press rollers 71 in order to imbed the granules into the hot bituminous compound upper layer 1. After traveling through a series of turns and gears, the composite sheet 2 is inverted such that the upper-exposed surface of the composite sheet 2 is now on the bottom side, and at about 160 degrees Celsius, the self-adhesive compound lower layer is applied at the coating vat 72. Following the self-adhesive lower layer application, the composite sheet 2 travels over a cooling belt 73 to permit cooling of the self-adhesive compound. A lower layer release liner is applied to the self-adhesive compound lower layer 7 using the release liner film applicator 74. Then, the composite sheet 2 travels through the accumulator 75 to the winder 76 where it is cut to the required length and wound into rolls

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the claims. Various publications are cited herein, the disclosures of which are incorporated by reference in their entireties.

What is claimed is:

1. A roofing material comprising release tape comprising a substrate and an adhesive capable of transfer from said substrate to said roofing material.

2. A roofing material of claim 1, wherein said release tape comprises an adhesive capable of transfer to a bituminous surface of the roofing material such that the adhesive transfers from the substrate to the bituminous surface of the roofing material upon removal of the substrate.

3. A release tape for roofing material comprising a substrate coated with an adhesive, wherein said adhesive is transferred to said roofing material upon removal of the substrate.

4. A process for manufacturing roofing material having release tape having a substrate with adhesive capable of transfer to the roofing material comprising applying to the membrane sheet a removable release tape pre-treated with an adhesive, such that the adhesive contacts the membrane sheet.

5. A process for manufacturing roofing material having release tape comprising a substrate with adhesive capable of transfer to the roofing material, comprising applying to the roofing material a removable release tape comprising a substrate pre-treated with an adhesive, such that the adhesive contacts the roofing material.

6. A roofing material of claim 1, wherein the release tape comprises a protective layer.

7. A release tape of claim 3, wherein the release tape comprises a protective layer.

8. A process according to claim 5, further comprising applying a protective layer to the release tape.

9. A roofing material comprising release tape comprising a substrate and a pressure sensitive adhesive capable of transfer from said substrate to said roofing material, wherein said pressure sensitive adhesive is selected from the group consisting of SWIFT 81570, SWIFT 2H776, SWIFT 84491, SWIFT 84024, and combinations thereof.

10. A roofing material comprising release tape comprising a substrate and a tackifier capable of transfer from said substrate to said roofing material, wherein said tackifier polyvinyl butyral.

11. A release tape comprising a substrate and a pressure sensitive adhesive capable of transfer from said substrate to said roofing material, wherein said pressure sensitive adhesive is selected from the group consisting of SWIFT 81570, SWIFT 2H776, SWIFT 84491, SWIFT 84024, and combinations thereof.

12. A release tape comprising a substrate and a tackifier capable of transfer from said substrate to said roofing material, wherein said tackifier polyvinyl butyral.
